(19) United States
(12) Patent Application Publication
(10) Pub. No.: US 2011/0133984 A1
(43) Pub. Date: Jun. 9, 2011

(54) Devices, Systems and Methods for Locating a Positioning Satellite

(75) Inventors: John Potts Davis, III, Marietta, GA (US); Justin Michael Anthony McNamara, Atlanta, GA (US); Jay Daryl Rector, Loganville, GA (US)

(73) Assignee: AT&T MOBILITY II LLC, Atlanta, GA (US)

(21) Appl. No.: 12/631,930

(22) Filed: Dec. 7, 2009

(51) Int. Cl. G01S 19/25; G06F 17/30

(52) U.S. Cl. 342/357.64; 707/E17.018; 707/722

(57) ABSTRACT

A mobile communication device is disclosed which receives a Base Station Transceiver (BTS) broadcast that identifies the serving cell coordinates, PLMN information, etc. The device determines an approximate location in Europe, and uses this information to invoke an almanac containing information about GALILEO satellites rather than GPS satellites. Consequently, broadcast network identifiers are used to determine an appropriate satellite constellation.

### CROSS REFERENCE TO RELATED APPLICATIONS

The present invention is related to commonly owned and co-pending U.S. patent application Ser. No. ______ filed ______, entitled “DEVICES, SYSTEMS, AND METHODS FOR PROVIDING LOCATION INFORMATION OVER A CELLULAR NETWORK”, which is incorporated by reference herein in its entirety.

### BACKGROUND OF THE INVENTION

1. Field of the Invention

The present invention relates to positioning satellite systems. More particularly, the present invention relates to providing assistance data to a mobile communication device so that the device can ascertain which positioning satellite to communicate with.

2. Background of the Invention

Mobile communication devices are becoming increasingly ubiquitous. Cellular transceivers can be found in several portable and fixed devices that can further communicate over other types of networks. For instance, a cellular telephone can include a positioning satellite receiver. To provide location information for a mobile communication device, a logic on the device queries a cellular network to obtain assistance data. The assistance data enables the positioning satellite receiver to tune in to signals from a specific satellite or set of satellites. If the device is successfully able to calculate a geographical position from the received positioning signals, that location information can be applied to several location-based services, for instance, live weather, directions, security, and so on. The query typically includes, inter alia, an identifier of a cell (Cell ID) that the device is communicating with. Assistance data in turn includes a list of satellites specific to the location of the cell, ephemeris information for each satellite, etc. Ephemeris information lists positions for specific satellites at a given time, and therefore turns obsolete in a few hours.

GALILEO is a global navigation satellite system (GNSS) currently being built by the European Union (EU) and European Space Agency (ESA). GALILEO is an alternative and complementary to the US-owned GPS system, and the Russian-owned GLONASS. When roaming, an American device programmed to receive signals from a Global Positioning System (GPS) satellite might be unable to connect to the GPS satellite. This happens, for instance, when a European service provider provides location data for a European cell ID, and the American device is unable to process the location. If the GPS system is inaccessible for any such reason, or inactivated during wartime, these devices may become seriously crippled.

What is needed is a means for providing a location of a mobile communication device that is efficient and reliable in other countries.

### SUMMARY OF THE INVENTION

The present invention addresses the above-identified problems by providing devices, systems, and methods for determining an approximate location of a mobile communication device, and retrieving the appropriate positioning satellites from an almanac. A base transceiver station (BTS) broadcasts assistance data across a control channel. The assistance data is received by a mobile communication device in communication with the BTS. The assistance data includes location information for the BTS, and Public Land Mobile Network (PLMN) information associated with the BTS. The assistance data can be broadcast by incorporating these fields in a control channel between the BTS and the mobile communication device. Mobile communication devices with positioning satellite receivers correlate the received assistance data with location database to derive an approximate location. Based on the approximate location, the location logic on the mobile communication device retrieves a set of satellites from an appropriate positioning satellite almanac. Devices without a positioning satellite receiver or devices unable to connect to a satellite correlate the received assistance data to a known approximate location, by referring to a database stored on the device or on the network.

In one exemplary embodiment, the present invention is a mobile communication device, including a processor, a memory in communication with the processor, a location logic on the memory, a transceiver in communication with the processor, and a positioning satellite receiver. The location logic receives assistance data from a base transceiver station broadcast, derives an approximate location from the assistance data, correlates the assistance data with a positioning satellite almanac based on the approximate location, retrieves a positioning satellite identifier from the positioning satellite almanac, and initiates communication with the positioning satellite. The positioning satellite can be a GALILEO satellite.

In another exemplary embodiment, the present invention is a system for communicating with a positioning satellite, the system including a mobile communication device having a positioning satellite receiver, a base transceiver station in communication with the mobile communication device, a server logic in communication with the base transceiver station, the server logic transmitting assistance data to the mobile communication device via a base transceiver station broadcast, and a location logic on the mobile communication device. The location logic derives an approximate location from the assistance data, correlates the assistance data with a positioning satellite almanac based on the approximate location, retrieves a positioning satellite identifier from the positioning satellite almanac, and initiates communication with the positioning satellite. The system further includes an application logic that provides a service based on the approximate location.

In yet another embodiment, the present invention is a method for communicating with a positioning satellite, the method including receiving location data from a base transceiver station broadcast, deriving an approximate location from the assistance data, correlating the assistance data with a positioning satellite almanac based on the approximate location, retrieving a positioning satellite identifier from the positioning satellite almanac, and receiving a positioning signal from the positioning satellite. The determining step further includes retrieving a geographical location corresponding to the assistance data, and determining an approximate location based on the geographical location.

The assistance data includes at least one of: a time of day, an MNC, an MCC, an LAC, and a coordinate set for the base transceiver station. If the assistance data indicates that the approximate location is in Europe, a GALILEO almanac is referred to when retrieving the positioning satellite identifier.

### BRIEF DESCRIPTION OF THE DRAWINGS

FIGS. 1A and 1B show a mobile communication device, according to an exemplary embodiment of the present invention.

FIG. 2 shows a system for communicating with a positioning satellite, according to an exemplary embodiment of the present invention.

FIG. 3 shows a method for communicating with a positioning satellite, according to an exemplary embodiment of the present invention.

FIG. 4 shows a mobile communication device deriving an approximate location from a base transceiver station broadcast, according to an exemplary embodiment of the present invention.

FIG. 5 shows a mobile communication device displaying a current approximate location, according to an exemplary embodiment of the present invention.

FIG. 6 shows mobile communication devices in different locations corresponding to a GPS and a GALILEO satellite, according to an exemplary embodiment of the present invention.

FIG. 7 shows an action diagram for determining a positioning satellite, according to an exemplary embodiment of the present invention.

### DETAILED DESCRIPTION OF THE INVENTION

The following detailed description and figures disclose devices, systems, and methods for determining an approximate location of a mobile communication device, and retrieving the appropriate positioning satellites from an almanac. A base transceiver station (BTS) broadcasts assistance data across a control channel. The assistance data is received by a mobile communication device in communication with the BTS. The assistance data includes location information for the BTS, and Public Land Mobile Network (PLMN) information associated with the BTS. The assistance data can be broadcast by incorporating these fields in a control channel between the BTS and the mobile communication device. Mobile communication devices with positioning satellite receivers correlate the received assistance data with location database to derive an approximate location. Based on the approximate location, the location logic on the mobile communication device retrieves a set of satellites from an appropriate positioning satellite almanac. Devices without a positioning satellite receiver or devices unable to connect to a satellite correlate the received assistance data to a known approximate location, by referring to a database stored on the device or on the network.

Assistance data can include the coordinates of a host cell or BTS. Coordinates are in the form (x, y) where ‘x’ indicates a latitude and ‘y’ indicates a longitude for the BTS or sector. The Public Land Mobile Network (PLMN) information includes identifiers such as a Mobile Country Code (MCC), Mobile Network Code (MNC), and a Location Area Code (LAC) associated with the BTS. The assistance data can be broadcast by incorporating these fields in a control channel between the BTS and the mobile communication device. The control channel broadcast includes cellular broadcast, broadcast SMS, data transaction, or equivalent broadcast from the network. In one embodiment, the network can periodically broadcast positioning satellite almanac information and its relative association with the MCC, MNC, and LAC of the carrier. This information is useful for determining which satellite system to use, for instance, GPS vs. GALILEO, as the mobile communication device may use the MCC, MNC, and LAC that is broadcast from the host cell to identify the proper satellites to search on according to the most recent almanac data stored on the mobile communication device. In other embodiments, the coordinates of the cell are made available to applications on the mobile communication device as a back-up in case of GPS failure. The coordinates enable provision of low accuracy information that may be valuable to applications that do not require high location precision.

“Mobile communication device”, as used herein and throughout this disclosure, refers to any electronic device capable of wirelessly sending and receiving data. A mobile communication device may have a processor, a memory, a transceiver, an input, and an output. Examples of such devices include cellular telephones, personal digital assistants (PDAs), portable computers, etc. In one embodiment, a mobile communication device is a handheld navigation device having a positioning satellite receiver. In another embodiment, a mobile communication device is a microcell or a femtocell. The memory stores applications, software, or logic. Examples of processors are computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories).

“Logic” as used herein and throughout this disclosure, refers to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

Mobile communication devices communicate with each other and with other elements via a network, for instance, a wireless network, or a wireline network. A “network” can include broadband wide-area networks, local-area networks, and personal area networks. Communication across a network is preferably packet-based; however, radio and frequency/amplitude modulations networks can enable communication between communication devices using appropriate analog-digital-analog converters and other elements. Examples of radio networks include cellular, GPRS, Wi-Fi, BLUETOOTH® networks, etc., with communication being enabled by hardware elements called “transceivers.” Some mobile communication devices may have more than one transceiver, capable of communicating over different networks. For example, a cellular telephone can include a GPRS transceiver for communicating with a cellular base station, a Wi-Fi transceiver for communicating with a Wi-Fi network, and a positioning satellite receiver for receiving a signal from a positioning satellite. A network typically includes a plurality of elements that host logic for performing tasks on the network. In modern packet-based wide-area networks, servers may be placed at several logical points on the network. Servers may further be in communication with databases and can enable communication devices to access the contents of a database. A server can span several network elements, including other servers in the cellular network.

A Base Transceiver Station (BTS) includes a plurality of antennae, and facilitates communication between a mobile communication device and a network. In one embodiment, a Base Transceiver Station (BTS) includes three unidirectional antennae. Each antenna serves an area that is a sector or a part of a sector. A sector is an area served by one or more antennae from one or more BTS's. A BTS transmits assistance data to the mobile communication device across a control channel. Assistance data includes location information for the BTS and/or its antennae. Assistance data can be embedded in fields within a control channel. For instance, coordinates for a BTS can be embedded in the Cell ID field of a Broadcast Control Channel (BCCH). Other assistance data can be embedded in a BCCH, Common Control Channel (CCCH), or a Dedicated Control Channel (DCCH). Assistance data enables a device to ascertain a proximate location, or to tune into positioning signals to ascertain an exact location. A proximate location could range from a state, city within the state, locality, a BTS serving the locality, or a sector served by one of the antennae of the BTS. An exact location is as precise as can be allowed by the number and quality of signals provided by positioning satellites.

For the following description, it can be assumed that most correspondingly labeled structures across the figures (e.g., 132 and 232, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

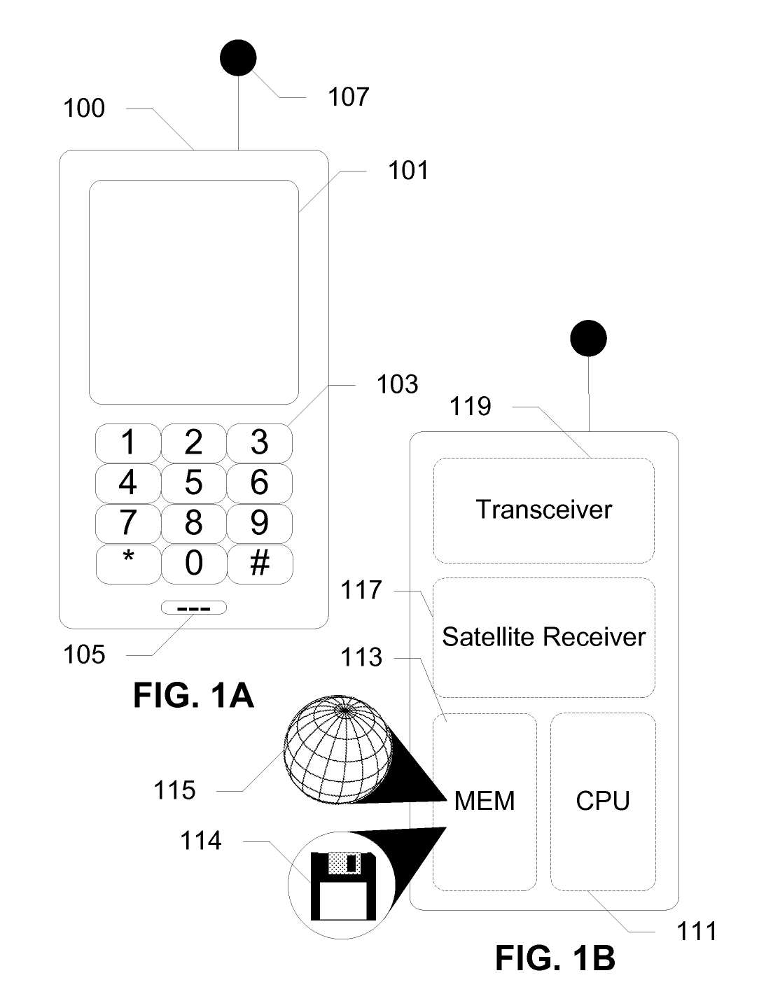

FIGS. 1A and 1B show a mobile communication device for approximating location, according to an exemplary embodiment of the present invention.

FIG. 1A shows the external components of the mobile communication device 100, according to an exemplary embodiment of the present invention. Mobile communication device 100 includes display 101, keypad 103, microphone 105, and antenna 107. Display 101 is a liquid-crystal display (LCD) which gives a user of mobile communication device 100 a visual output. Keypad 103 is an alphanumeric arrangement of buttons which gives the user tactile input. Microphone 105 gives the user audio input so that the user may talk to the user of another mobile communication device, provide voice command input, or record sound.

FIG. 1B shows the internal components of mobile communication device 100, according to an exemplary embodiment of the present invention. Mobile communication device 100 includes processor (CPU) 111, memory 113 having location logic 114 and approximate location database 115, satellite receiver 117, and transceiver 119. Processor 111 is preferably a mobile processor and performs calculations according to logic stored on memory 113. Memory 113 is a computer readable medium known as random access memory (RAM) which stores logic, user information, contact information, etc. Transceiver 119 is a cellular radio frequency (RF) transmitter and receiver which allows mobile communication device 100 to communicate wirelessly across a network. This enables mobile communication device 100 to share information other electronic devices, issue and execute commands, etc. Location logic 114 is an algorithm which determines the location of mobile communication device 100 to the best accuracy with the given information. Location database 115 is a database which, among other things, links received assistance data with approximate location identifiers, such as a city, state, locality, or zip code. Location database 115 can also include a positioning satellite almanac, linking locations and times to a plurality of positioning satellites. Multiple almanacs can be included such as a GPS almanac, or a GALILEO almanac. These almanacs can be downloaded from a network or updated when needed.

Mobile communication device 100 can provide a service to the user through an application that requires a current location. A base transceiver station broadcasts assistance data. Mobile communication device 100 receives this assistance data through transceiver 119. Transceiver 119 decodes the assistance data and forwards the assistance data to processor 111. Location logic 114 uses the assistance data to determine an approximate location of mobile communication device 100. The assistance data may take different forms, such as a longitude and latitude of the base transceiver station. This is given in the form of two numbers, one being the latitude and the other being the longitude. Location logic 114 uses these coordinates to approximate a location of mobile communication device 100. This can be done by referring to approximate location database 115. Assistance data can also include information associated with the PLMN, such as MNC, MCC, LAC, etc. The PLMN information can also be associated with an approximate location by referring to location database 115. Once the approximate location is determined, location logic 114 uses the approximate location to instruct satellite receiver 117 as to which positioning satellites to receive signals from. For instance, given a European PLMN, the device will connect to one or more GALILEO satellites. Once an exact location is determined from signals from a set of positioning satellites, a service can be provided based on the exact location. Services such as directions, weather, local sports scores, local places, etc., can be provided by different applications on memory 113.

In some embodiments the mobile communication device is a substantially simpler device, such as a standalone weather communicator, or a weather-reporting unit coupled to a multi-function device. In these embodiments the mobile communication device may not have a microphone or display. There may be limited applications on the memory, in many cases only one. These mobile communication devices receive broadcasts from the BTS over a control channel, such as a BCCH, emergency channel, etc., and approximate a location using a location logic and an approximate location database. A positioning satellite almanac is invoked to determine an exact location. In the case of a standalone weather communicator, a speaker can be used to audibly communicate the weather to the user periodically, or in the event of a warning.

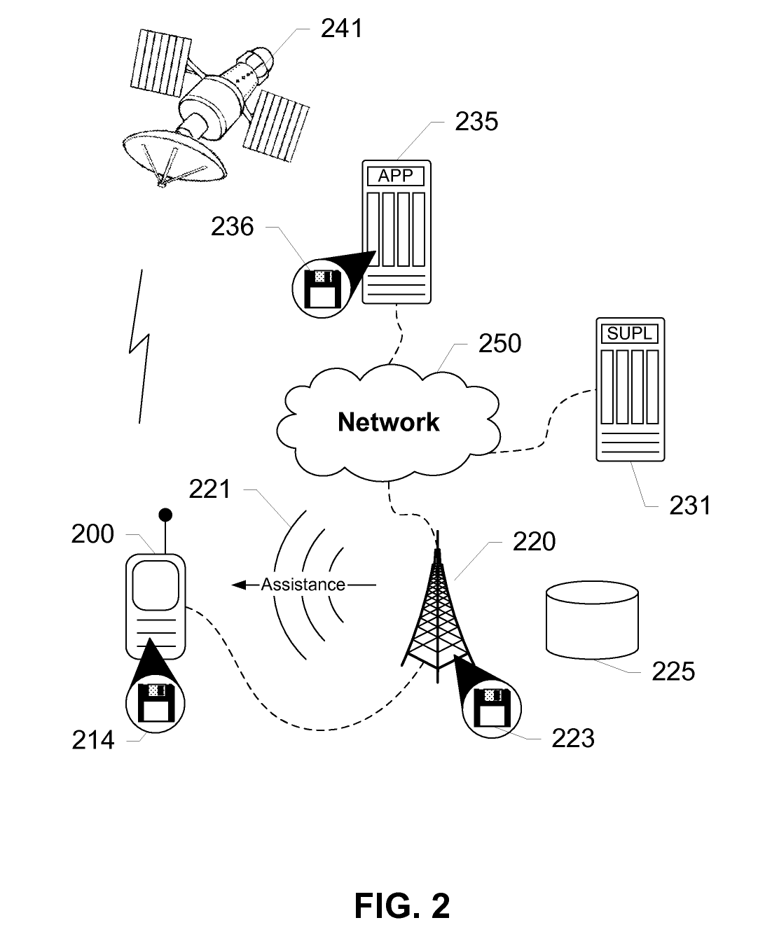

FIG. 2 shows a system for providing location information, according to an exemplary embodiment of the present invention. A mobile communication device 200, including a location logic 214, is in communication with a base transceiver station (BTS) 220 having server logic 223 and assistance database 225. BTS 220 includes several components that communicate with and enable device 200 to communicate with network 250. Network 250 includes Secure User Plane Location (SUPL) server 231, and application server 235 having application logic 236.

Mobile communication device 200 uses location logic to determine an approximate location using assistance data. Assistance data may come from a control channel broadcast 221 received from base transceiver station 220, or from SUPL server 231. BTS logic 223 retrieves the assistance data from assistance database 225 which contains the latitude and longitude of the base transceiver station. Assistance data may also come from SUPL server 231. SUPL server 231 transmits the assistance data across the network to mobile communication device 200. Once mobile communication device 200 receives the assistance data, a location can be determined. Mobile communication device 200 uses location logic 214 to approximate a location. Once the location has been approximated mobile communication device 200 may send that information to application server 235, or may communicate with positioning satellite 241 in order to obtain a more exact location. Application logic 236 on application server 235 provides a service to mobile communication device 200. Application logic 236 needs to know the location of mobile communication device 200 in order to provide the service. Application logic 236 may provide general location-based services using an approximate location, such as a weather report, local business information, etc. Application logic 236 can also provide precise location-based services such as mapping, directions, etc.

In one exemplary embodiment using this system, a user of mobile communication device 200 uses an application that requests a location to provide a service. Base transceiver station 220 uses server logic 223 to broadcast the longitude and latitude through the control channel broadcast 222. Mobile communication device 200 receives a control channel broadcast 222 including assistance data. Mobile communication device 200 then uses the assistance data to determine an approximate location. From the approximate location mobile device 200 can request a service from application server 235 or connect to positioning satellite 241 for a more precise location.

Within the control channel, base transceiver station 220 may broadcast the assistance data in several formats. The cell ID may contain the assistance data in the form of a longitude and latitude, a zip code, etc. Ephemeris data may be broadcast through the control channel as well or downloaded directly from the positioning satellite. Alternately, a separate portion of the control channel may be used to broadcast the longitude and latitude along with the time of day and the ephemeris data for the closest positioning satellites. The broadcast information need only include assistance data for a corresponding set of satellites available in that location. Therefore the assistance data includes information for GPS, GALILEO, and other systems. This broadcast information allows applications to have access to assistance data without having to perform a separate query to the network. If the mobile communication device does not support GPS, then the mobile communication device can still use the approximate location to provide a service. In some embodiments, an application is stored on the memory of the mobile communication device instead of on the application server.

In another exemplary embodiment using this system, BTS 220 broadcasts an LAC, MNC, and MCC. Location logic 214 on mobile communication device 200 uses an approximate location database to match the LAC, MNC, and MCC with an approximate location. Once the approximate location is determined, mobile communication device 200 can request a service from application server 235 or communicate with positioning satellite 241 for a more accurate location.

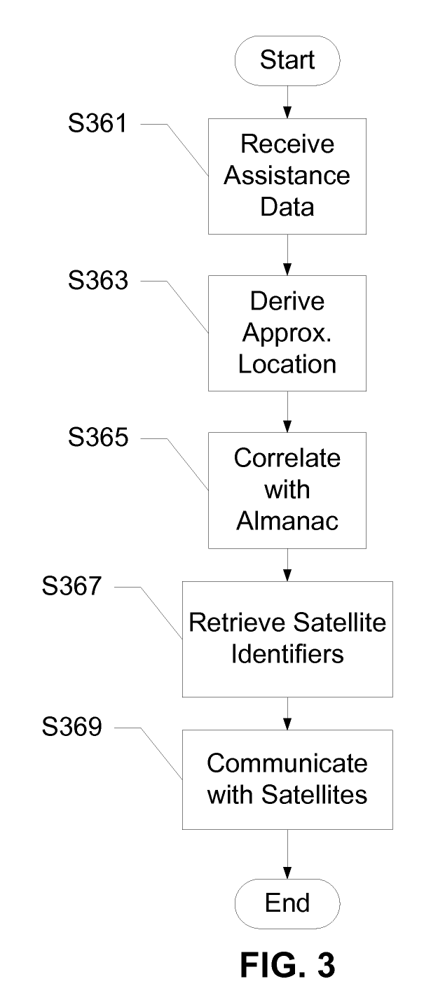

FIG. 3 shows a method for approximating location, according to an exemplary embodiment of the present invention. The method starts when a mobile communication device is switched on, or when a communication link is established between the mobile communication device and a network. The mobile communication device receives assistance data S361. The assistance data may come from a SUPL server across a network or is broadcast from a base transceiver station. A location database is invoked to determine an approximate location based on the assistance data S363. The approximate location database includes, for instance, a city/state, zip code, or equivalent geographic identifier that can be correlated with received assistance data. Based on the approximate location, the appropriate positioning satellite almanac is invoked. The almanac is used to determine which positioning satellites to communicate with. The almanac is valid for approximately 180 days, and is updated and stored on the mobile communication device as needed. The mobile device correlates the location data with the almanac S365, and retrieves satellite identifiers S367 for a set of positioning satellites to look for when receiving positioning signals. Typically, at least four positioning satellites are required for a triangulated location result accurate to a few meters. Based on the received satellite identifiers, the satellite receiver on the mobile communication device knows which satellites to receive, and establishes communication with the satellites S369.

In another embodiment, the correlation with the almanac does not include determining an appropriate almanac, but simply includes determining the set of satellites from a plurality of different types of satellites. For instance, a hybrid almanac includes GPS, GALILEO, and other satellites. Depending upon the assistance data, and the approximate location, the appropriate satellites identifiers can be retrieved.

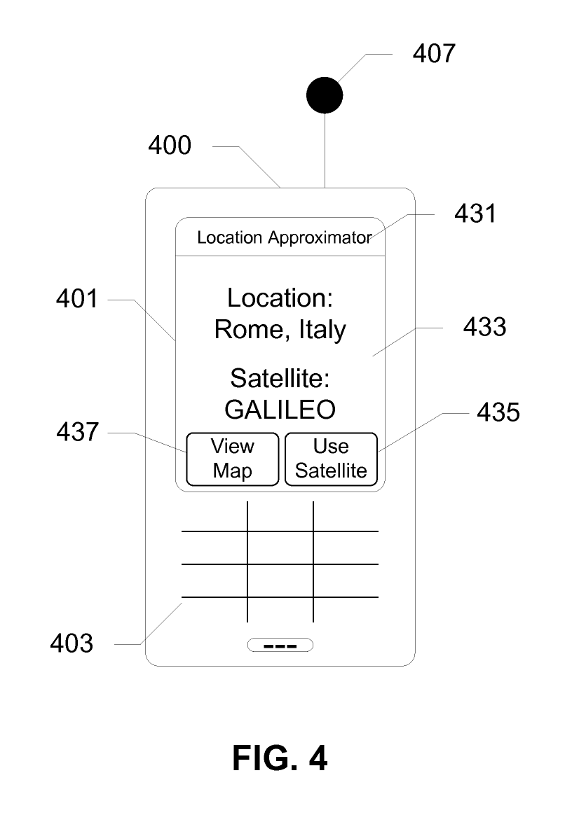

FIG. 4 shows a mobile communication device deriving an approximate location from a base transceiver station broadcast, according to an exemplary embodiment of the present invention. In this embodiment, mobile communication device 400 includes a screen 401 and a keypad 403. Screen 401 is an LCD or LED screen on which a user can view selections, numbers, letters, etc. including Location Approximator 431. Screen 401 can also be a touchscreen, allowing a user to select inputs directly on screen 401. Keypad 403 is typically used as an input device, for instance, to type a telephone number, type a message, make a selection from screen 401, etc. In this screenshot, screen 401 is displaying a Location Approximator application 431. Location Approximator 431 receives and parses assistance data from a base transceiver station broadcast, such as a broadcast SMS channel. Location Approximator 431 includes a message body 433, stating the approximate location. In this case the location is Rome, Italy. Message body 433 also includes the appropriate positioning satellite system to be used. In this case the appropriate positioning satellite system is GALILEO. The approximate location is derived by correlating PLMN or BTS location information in the assistance data with a location database on device 400. The satellite information can also be retrieved from the location database, or may be received in the broadcast from the BTS. The derived approximate location can be mapped via a View Map selection 437, and an exact location can be determined by a Use Satellite selection 435. View Map selection 437, when selected, displays a map with the sector coordinates from message body 433 and a surrounding area. This informs the user of their approximate location. Use Satellite selection 435, when selected, correlates the assistance data of in the broadcast, or the approximate location, with the appropriate positioning satellite almanac to locate a set of appropriate positioning satellites. In this case the appropriate satellites are GALILEO satellites. For instance, coordinates of a BTS, or PLMN information within the broadcast are compared with the almanac to determine the location of the GALILEO satellites at that specific time and place. Ephemeris data can be received across the network, or downloaded from the appropriate positioning satellites. Other assistance data may be provided with the broadcast and extracted for use by other applications.

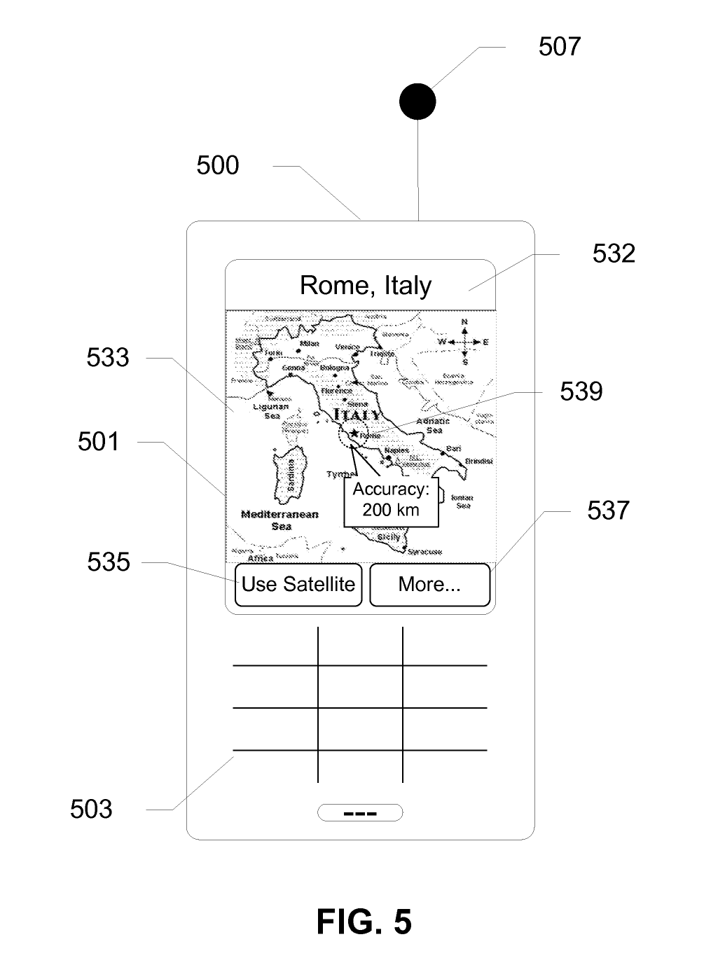

FIG. 5 shows a mobile communication device 500 displaying a current approximate location 532, according to an exemplary embodiment of the present invention. In this embodiment, mobile communication device 500 includes a display 501 and a keypad 503. Keypad 503 allows a user to make selections from screen 501. Display 501 visually outputs location notification 532, which includes a map 533 indicating an approximate location 539, defined at the center of a radius of uncertainty. Although the approximate location 539 is indicated by a circle, other regions can be defined based upon a configuration of BTS's and associated antennae, for instance, a hexagon reflecting the shape of a cell. A use GPS selection 535 and a more options selection 537 provide added functions.

Map 533 shows an area surrounding a coordinate set sent from a base transceiver station in Rome, Italy. Map 533 may be zoomed in or out using keypad 503 as input or a touchscreen embodiment of display 501. Map 533 may be a road map, topographical map, traffic map, weather map, etc. The approximate location with radius of uncertainty 539 is shown on map 532. The approximate location in this case is the city of Rome, in the country of Italy. This information is derived by correlating the coordinates or PLMN information sent from the base transceiver station with a map or database of the region or country, stored in an approximate location database on mobile communication device 500. The BTS communicates with the mobile communication device, but the exact location is not determined because no positioning signals are received from a positioning satellite. Therefore, the BTS transmits the location where the center of cellular coverage is, and applies a radius of uncertainty substantially encompassing the entire coverage area depending on the required precision.

Use Satellite selection 535, when selected, invokes a positioning satellite almanac to locate appropriate GALILEO satellites. The coordinates, PLMN, or derived approximate location is compared with the almanac and ephemeris data on a memory of mobile communication device 500 to determine the location of the GALILEO satellites at that specific time and place. The almanac and ephemeris data include approximately where each GALILEO satellite will be at a certain time with respect to the location of the coordinates. The information may be periodically updated from the network. More options selection 537, when selected, allows the user to select from different applications that utilize the coordinates. These applications include location-based services, such as a weather forecast, local business search, etc.

There are many applications which utilize the coordinates or the approximate location derived from the coordinates. Applications may reside wholly on a mobile communication device, wholly on a server, or any combination thereof. The server may be an application server on a service provider's network, a web server on the INTERNET, etc. Applications utilize the coordinates/approximate location of the mobile communication device for any information related to an area including the cell. The area may be a neighborhood, a town, a city, a county, a state, a zip code, an area code, etc. The user information derived from the area may be news, weather, business search results, business coupons, disaster warnings, events, etc.

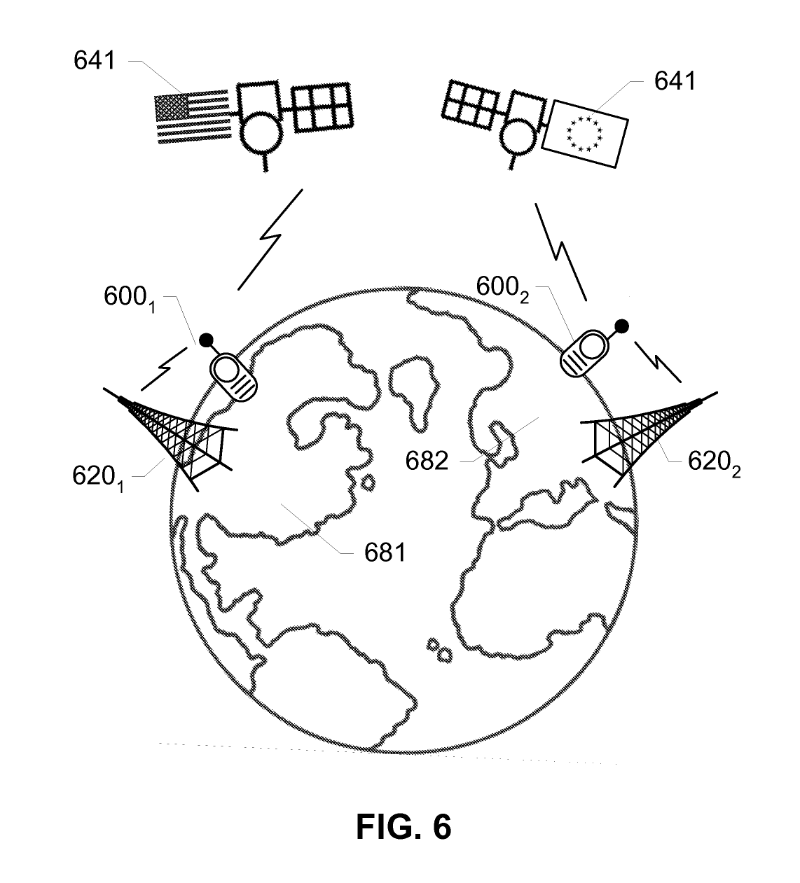

FIG. 6 shows mobile communication devices in different locations respectively communicating with a GPS and a GALILEO satellite, according to an exemplary embodiment of the present invention. Mobile communication device 600₁ is in the US 681, and communicates with BTS 620₁, operated by an American carrier. Consequently, a broadcast from BTS 620₁ includes PLMN information or coordinates that represent the United States. Using the methods described herein, mobile communication device 600₁ invokes a GPS almanac to communicate with an American GPS satellite 641.

Similarly, mobile communication device 600₂ is being used in Europe 682, and communicating with a European BTS 620₂. Consequently, PLMN and coordinate information, as well as assistance information broadcast from BTS 620₂ includes geographical identifiers corresponding to whatever country in Europe that mobile communication device 600₂ is in. By plugging this information into a location database, mobile communication device 600₂ determines that the approximate location is within Europe. Consequently, it invokes a GALILEO almanac that instructs mobile communication device 600₂ to receive positioning signals from European GALILEO satellite 641.

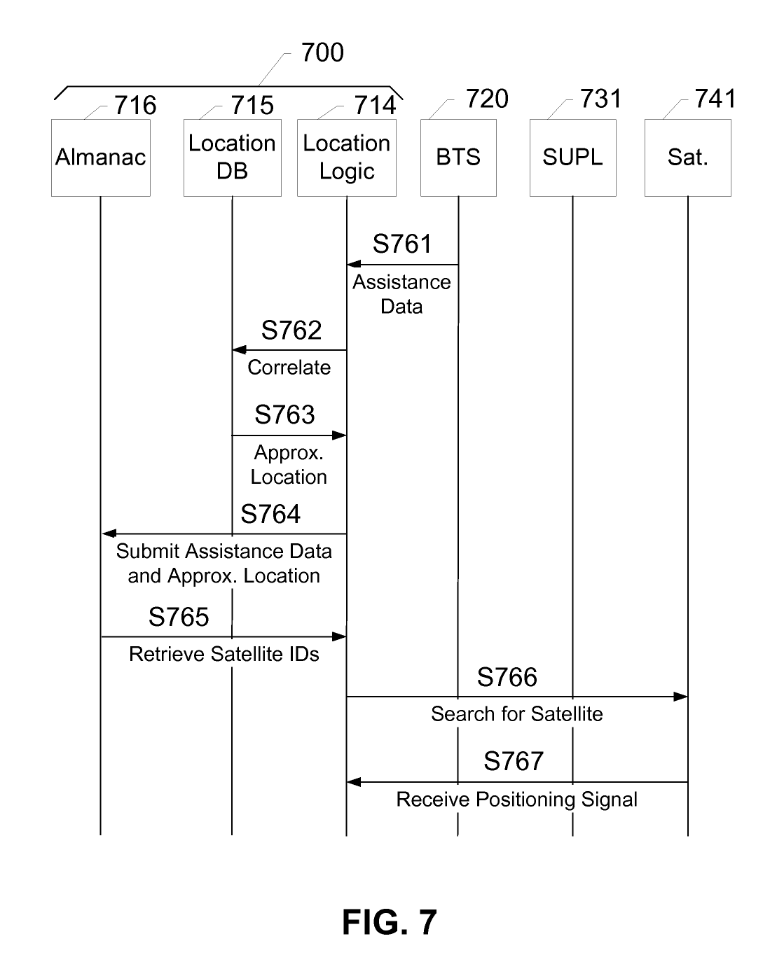

FIG. 7 shows an action diagram for determining a positioning satellite, according to an exemplary embodiment of the present invention. A mobile communication device 700 includes a location logic 714, location database 715, and a positioning satellite almanac 716. BTS 720 provides a connection to the network. BTS 720 broadcasts assistance data S761. The assistance data need not come from a SUPL server 731, thereby eliminating the need to submit a request, and consequently saving network resources. A location database 715 is invoked S762 to determine an approximate location based on the assistance data. The location database 715 includes, for instance, a city/state, zip code, or equivalent geographic identifier that can be correlated with received assistance data. Based on the approximate location received S763, the appropriate positioning satellite almanac 716 is invoked S764. The almanac 716 uses the assistance data, possibly including the approximate location, to determine which positioning satellites to communicate with. The almanac 716 is valid for approximately 180 days, and is updated and stored on mobile communication device 700 as needed. Location logic 714 retrieves satellite identifiers S765 for a set of positioning satellites to look for when receiving positioning signals. Typically, at least four positioning satellites are required for a triangulated location result accurate to a few meters. Based on the received satellite identifiers, location logic 714 enables a satellite receiver on the mobile communication device 700 to search S766 for signals from specific satellites based on the satellite identifiers received. Once positioning signals are received S767, a precise location is calculated.

Correlation with the almanac may include determining an appropriate almanac, such as a GPS or GALILEO almanac. Alternatively, correlation simply includes determining the set of satellites from a plurality of different types of satellites, in case of a hybrid almanac including GPS, GALILEO, and other satellite constellations.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A mobile communication device comprising:
a processor;
a memory in communication with the processor;
a location logic on the memory;
a transceiver in communication with the processor; and
a positioning satellite receiver;
wherein the location logic
receives assistance data from a base transceiver station broadcast;
derives an approximate location from the assistance data;
correlates the assistance data with a positioning satellite almanac based on the approximate location; and
retrieves a positioning satellite identifier for a positioning satellite from the positioning satellite almanac; and

2. The device of claim 1, wherein the location logic
derives an approximate location in Europe, and
retrieves a positioning satellite identifier for a GALILEO satellite.

3. The device of claim 1, further comprising:
a database stored on the memory, the database including a geographical location corresponding to the received assistance data,
wherein the location logic derives the approximate location by comparing the received assistance data with the corresponding geographical location in the database.

4. The device of claim 1, wherein the assistance data includes a time of day, and at least one of: a Mobile Network Code (MNC), a Mobile Country Code (MNC), and a Location Area Code (LAC).

5. The device of claim 1, wherein the assistance data includes a base transceiver station coordinate set.

6. The device of claim 1, wherein the assistance data includes a base station sector coordinate set.

7. The device of claim 1, wherein the positioning satellite receiver receives ephemeris data from the positioning satellite.

8. The device of claim 1, wherein the location logic receives ephemeris data from the base transceiver station broadcast.

9. A system for communicating with a satellite, the system comprising:
a mobile communication device having a positioning satellite receiver;
a base transceiver station in communication with the mobile communication device;
a server logic in communication with the base transceiver station, the server logic transmitting assistance data to the mobile communication device via a base transceiver station broadcast;
a location logic on the mobile communication device, wherein the location logic:
derives an approximate location from the assistance data,
correlates the assistance data with a positioning satellite almanac based on the approximate location,
retrieves a positioning satellite identifier from the positioning satellite almanac;
and
a positioning satellite that transmits a positioning signal to the mobile communication device

10. The system of claim 9, wherein the location logic
derives an approximate location in Europe, and
retrieves a positioning satellite identifier for a GALILEO satellite.

11. The system of claim 9, further comprising:
a database stored on a memory of the mobile communication device, the database including a geographical location corresponding to the received assistance data,
wherein the location logic derives the approximate location by comparing the received assistance data with the corresponding geographical location in the database.

12. The system of claim 9, wherein the assistance data includes a time of day, and at least one of: a Mobile Network Code (MNC), a Mobile Country Code (MNC), and a Location Area Code (LAC).

13. The system of claim 9, wherein the assistance data includes a base transceiver station coordinate set.

14. The system of claim 9, wherein the assistance data includes a base station sector coordinate set.

15. The system of claim 9, wherein the positioning satellite receiver receives ephemeris data from the positioning satellite.

16. The system of claim 9, wherein the location logic receives ephemeris data from the base transceiver station broadcast.

17. A method for providing location based information comprising:
receiving location data from a base transceiver station broadcast;
deriving an approximate location from the assistance data;
correlating the assistance data with a positioning satellite almanac based on the approximate location;
retrieving a positioning satellite identifier from the positioning satellite almanac; and
receiving a positioning signal from a positioning satellite.

18. The method of claim 17, further comprising:
deriving an approximate location in Europe, and
receiving a positioning signal from a GALILEO satellite.

19. The method of claim 17, further comprising:
retrieving a geographical location corresponding to the assistance data; and
determining an approximate location based on the geographical location.

20. The method of claim 17, wherein the assistance data includes at least one of: a time of day, an MNC, an MCC, an LAC, and a coordinate set for the base transceiver station.
